(19) United States
(12) Patent Application Publication
(10) Pub. No.: US 2008/0105352 A1
(43) Pub. Date: May 8, 2008

(54) Reduced weight aircraft tire

(76) Inventors: Kiyoshi Ueyoko, Copley, OH (US); Robert John Boehlefeld, Brecksville, OH (US); Maure Ellen Knavish, Hartville, OH (US); Larry Lee Mershon, Medina, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/592,893

(22) Filed: Nov. 3, 2006

(51) Int. Cl. B60C 9/18

(52) U.S. Cl. 152/527

(57) ABSTRACT

A pneumatic tire having a carcass and a belt reinforcing structure wherein the belt reinforcing structure is a composite belt structure having at least one radially inner spiral layer and at least one zigzag belt reinforcing structure located radially outward of said spiral layer. The zigzag belt width is preferably narrower than the spiral layer.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

Pneumatic tires for high speed applications experience a high degree of flexure in the crown area of the tire as the tire enters and leaves the contact patch. This problem is particularly exacerbated on aircraft tires wherein the tires can reach speed of over 200 mph at takeoff and landing.

When a tire spins at very high speeds the crown area tends to grow in dimension due to the high angular accelerations and velocity, tending to pull the tread area radially outwardly. Counteracting these forces is the load of the vehicle which is only supported in the small area of the tire known as the contact patch.

Current tire design drivers are an aircraft tire capable of high speed, high load and with reduced weight. It is known in the prior art to use zigzag belt layers in aircraft tires, such as disclosed in the Watanabe U.S. Pat. No. 5,427,167. Zigzag belt layers have the advantage of eliminating cut belt edges at the outer lateral edge of the belt package. The inherent flexibility of the zigzag belt layers also help improve cornering forces. However, a tire designed with zigzag belt layers cannot carry as heavy a load as required by current commercial aircraft design requirements. Further, there is generally a tradeoff between load capacity and weight. Thus an improved aircraft tire is needed, which is capable of meeting high speed, high load and with reduced weight.

### Definitions

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65° and 90° with respect to the equatorial plane of the tire.

“Zigzag belt reinforcing structure” means at least two layers of cords or a ribbon of parallel cords having 1 to 20 cords in each ribbon and laid up in an alternating pattern extending at an angle between 5° and 30° between lateral edges of the belt layers.

### BRIEF DESCRIPTION OF THE DRAWINGS

FIG. 1 is a schematic section view of a first embodiment of the tire according to the invention;

FIG. 2 is a schematic perspective view of a zigzag belt layer in the middle of the formation;

FIG. 3 is a schematically enlarged section view of a first embodiment of a composite belt package showing the belt layer configuration;

FIG. 4 is a schematically developed section view of a second embodiment of a composite belt package showing the belt layer configuration;

FIG. 5 is a schematically developed section view of a third embodiment of a composite belt package showing the belt layer configuration;

FIG. 6 is a schematically developed section view of a fourth embodiment of a composite belt package showing the belt layer configuration;

FIGS. 7-10 illustrate several embodiments of the starting and ending belt cord edges of the belt layers.

### DETAILED DESCRIPTION OF THE INVENTION

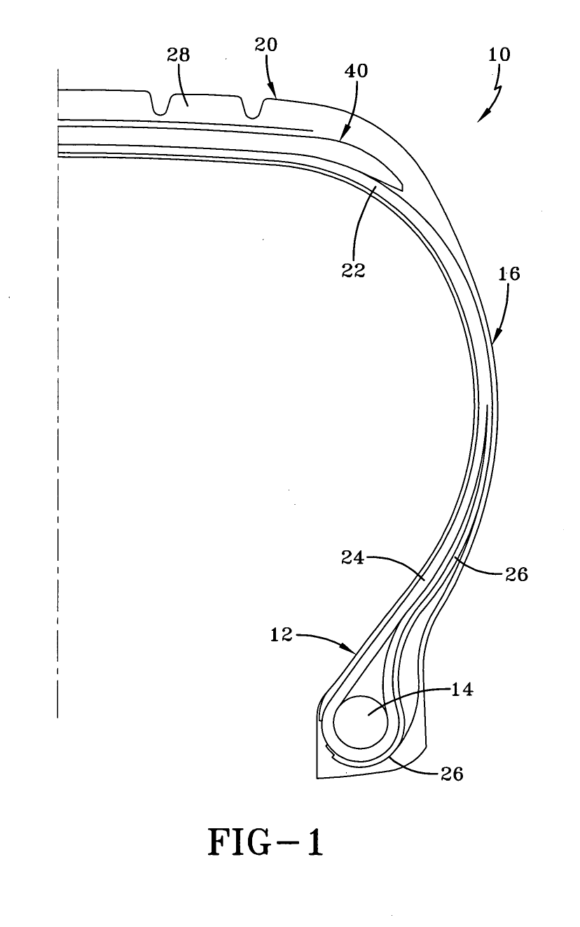

FIG. 1 illustrates a radial aircraft tire 10. As shown, the aircraft tire comprises a pair of bead portions 12 each containing a bead core 14 embedded therein. One example of a bead core suitable for use in an aircraft tire is shown in U.S. Pat. No. 6,571,847. A person skilled in the art may appreciate that other bead cores may also be utilized. The aircraft tire comprises a sidewall portion 16 extending substantially outward from each of the bead portions 12 in the radial direction of the tire, and a tread portion 20 of substantially cylindrical shape extending between radially outer ends of these sidewall portions 16. Furthermore, the tire 10 is reinforced with a carcass 22 toroidally extending from one of the bead portions 12 to the other bead portion 12. The carcass 22 is comprised of inner carcass plies 24 and outer carcass plies 26. Among these carcass plies, typically four inner plies 24 are wound around the bead core 14 from inside of the tire toward outside thereof to form turnup portions, while typically two outer plies 26 are extended downward to the bead core 14 along the outside of the turnup portion of the inner carcass ply 24. Each of these carcass plies 24,26 may comprise any suitable cord, typically many nylon cords such as nylon-6,6 cords extending substantially perpendicular to an equatorial plane EP of the tire (i.e. extending in the radial direction of the tire). A tread rubber 28 is arranged on the outside of the belt 40 in the radial direction. One or more of the carcass plies 24, 26 may also comprise an aramid and nylon cord structure, for example, a hybrid cord, a high energy cord or a merged cord. Examples of suitable cords are described in U.S. Pat. No. 4,893,665, U.S. Pat. No. 4,155,394 or U.S. Pat. No. 6,799,618.

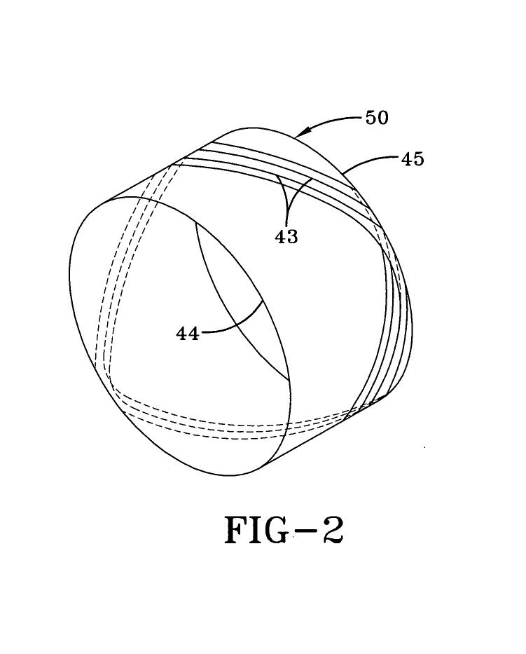

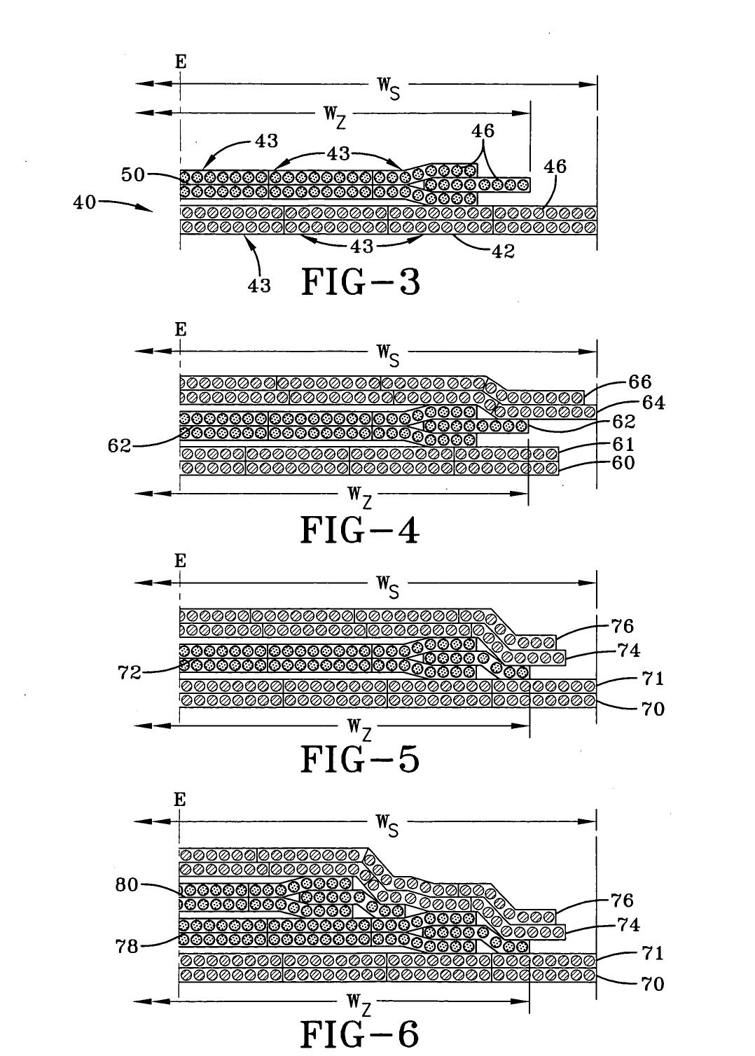

The aircraft tire 10 further comprises a belt package 40 arranged between the carcass 22 and the tread rubber 28. FIG. 3 illustrates a first embodiment of a belt package 40 suitable for use in the aircraft tire. The belt package 40 as shown comprises a radially inner spirally wound belt layer 42 formed of cord or a rubberized strip 43 of two or more cords made by spirally winding the cords at an angle of plus or minus 5 degrees or less relative to the circumferential direction. Preferably, the belt package comprises two or more zero degree belt layers. The belt package 40 further comprises one or more zigzag belt reinforcing structures 50. Each zigzag belt reinforcing structure 50 is comprised of two layers of cord. The zigzag belt reinforcing structure is formed as shown in FIG. 2. A rubberized strip 43 of one or more cords 46, wound generally in the circumferential direction while being inclined to extend between side ends or lateral edges 44 and 45 of the layer forming a zigzag path as shown. The strip is wound along such path many times while the strip 43 is shifted a desired amount in the circumferential direction so as not to form a gap between the adjoining strips 43. As a result, the cords 46 extend substantially zigzag in the circumferential direction while changing the bending direction at a turnaround point at both ends 44, 45. The cords 46 of the zigzag belt structure cross with each other, typically at a cord angle A of 5 degrees to 30 degrees with respect to the equatorial plane EP of the tire when the strip 43 is reciprocated at least once between both side ends 44 and 45 of the ply within every 360 degrees of the circumference as mentioned above. The two layers of cords 46 formed in each zigzag belt structure 50 are embedded and inseparable in the belt layer 50 and wherein there are no cut ends at the outer lateral ends of the belt.

As shown in FIG. 3, it is preferred that the zigzag belt structure 50 be located radially outward of the spiral belt layer 42. It is additionally preferred that the spiral belt layer be wider than the zigzag belt structure. The ratio of the zigzag belt width Wz to the spiral belt width is preferably as follows:

0.6≦Wz/Ws<1.0 (1)

The ratio of the zigzag belt width Wz to the spiral belt width is even more preferably as follows:

0.5≦Wz/Ws<0.98 (2)

The width of both the zigzag belt structure 50 and the spiral belt layer 42 may affect cornering performance and belt edge durability. If the zigzag belt layers are too narrow, cornering performance suffers. If the zigzag belt layers are too wide, the belt edge durability drops.

FIG. 4 illustrates a second embodiment of the present invention having two inner spirally wound layers 60,61, an inner zigzag structure 62 and two radially outer spirally wound belt layers 64, 66. The radially outer spiral layers 64, 66 may be wider than the zigzag belt structure 62. The outer spirally wound layers 64, 66 may be wider than the inner spiral layers 60, 61. The ratio of the zigzag belt width Wz to the widest spiral belt Ws width may be as follows:

0.6≦Wz/Ws<1.0 (1)

More particularly, the ratio of the zigzag belt width Wz to the widest spiral belt width may be as follows:

0.5≦Wz/Ws<0.98 (2)

FIG. 5 illustrates a third embodiment of the belt layer. FIG. 5 is similar to FIG. 4 in that the there are two inner spiral layers 70, 71, an inner zigzag structure 72 and two radially outer spirally wound belt layers 74, 76. In addition, the belt ends of the radially outer belt layers are wrapped around the zigzag belt structure. FIG. 5 differs from FIG. 4 in that the radially inner spiral layers 70, 71 are wider than the zigzag belt structure 72. In the third embodiment, the inner spirally wound layers 70, 71 are wider than the outer spiral layers 74, 76. The inner spiral layer 70, 71 may be the widest belt layer. The ratio of the zigzag belt width Wz to the widest spiral belt width may be as follows:

0.6≦Wz/Ws<1.0 (1)

The ratio of the zigzag belt width Wz to the widest spiral belt width may also be as follows:

0.5≦Wz/Ws<0.98 (2)

FIG. 6 illustrates a fourth embodiment of the belt structure. FIG. 6 is similar to FIG. 5, having two radially inner spiral layers 70, 71, two radially outer spiral layers 74, 76. However FIG. 6 has two zigzag belt structures 78, 80 instead of one zigzag belt structure 78. The zigzag belt structures 78, 80 may be staggered in width, wherein the radially inner zigzag belt structure 78 is wider than the radially outer zigzag belt structure 80. The ratio of the zigzag belt width Wz to the widest spiral belt width may be as follows:

0.6≦Wz/Ws<1.0 (1)

The ratio of the zigzag belt width Wz to the widest spiral belt width may also be as follows:

0.5≦Wz/Ws<0.98 (2)

In any of the above described embodiments, the cord may be continuously wound from one layer to the next.

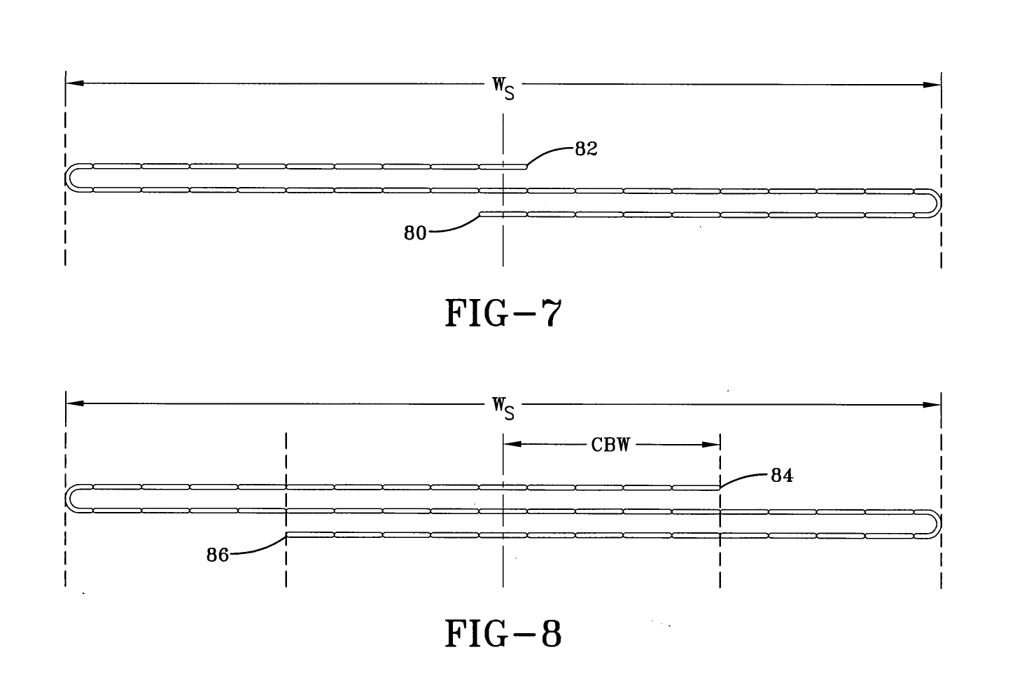

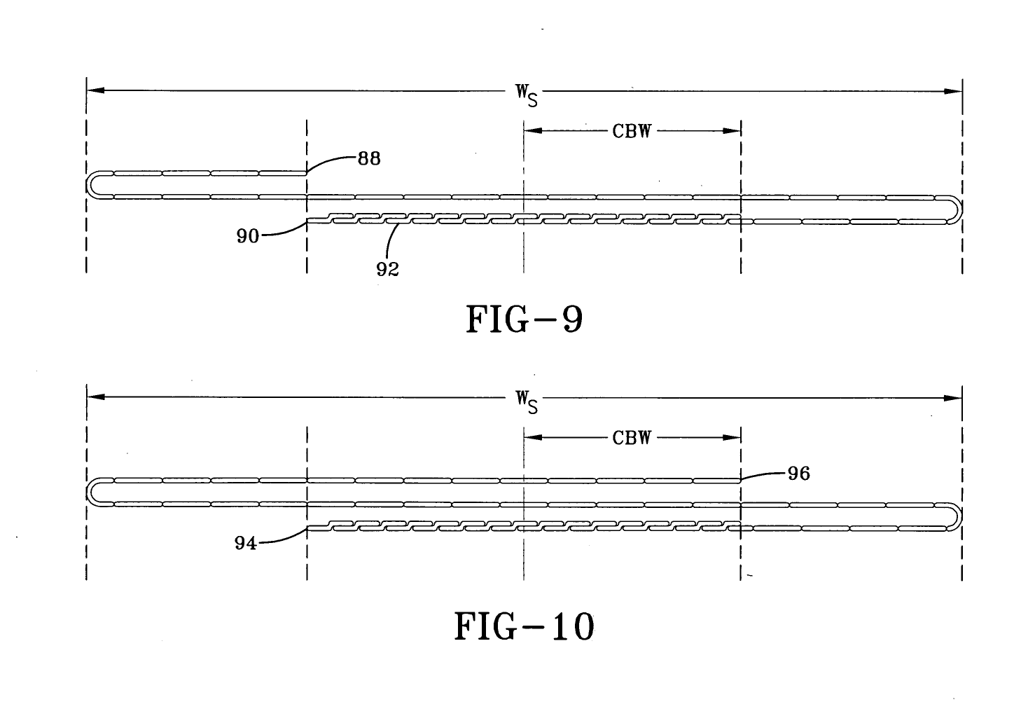

FIGS. 7 through 10 illustrate various starting and ending belt edge configurations for any of the spirally wound belt layers described above. In FIG. 7, the starting belt edge 80 and the ending belt edge 82 overlap near the center of the belt. In the areas of overlap, there are three layers of cord. FIG. 8 illustrates a spiral wound belt layer wherein the starting end 86 and ending belt edge 84 overlap, and each belt edge is offset up to ¼ the belt width as measured from the center of the belt (½ belt width as measured from one belt edge 84 to the other belt edge 86). FIG. 9 illustrates that the starting end 88 and ending belt edge 90 are approximately in the same location and offset from the center an offset distance up to ¼ the belt width as measured from the center. One of the belt ends 90 is formed with an overlapping strip 92 so that the strips are overlapped approximately half the strip width. The result is that there are effectively three layers of cord in the overlapped area. FIG. 10 is the same as FIG. 9, except the belt ends 94, 96 are offset from the center up to ¼ the belt width. Thus there are four effective layers of cord. The additional layer(s) provide reinforcement in the crown which is where the highest stress occurs

The cords of any of the above described carcass, spiral or zigzag belt layers described above may be nylon, nylon 6,6, aramid, or combinations thereof, including merged, hybrid, high energy constructions known to those skilled in the art. One example of a suitable cord construction for the belt cords, carcass cords (or both), may comprise a composite of aramid and nylon, containing two cords of a polyamide (aramid) with construction of 3300 dtex with a 6.7 twist, and one nylon or nylon 6/6 cord having a construction of 1880 dtex, with a 4.5 twist. The overall merged cable twist is 6.7. The composite cords may have an elongation at break greater than 11% and a tensile strength greater than 900 newtons. Optionally, the original linear density may be greater than 9000 dtex. Elongation, break, linear density and tensile strength are determined from cord samples taken after being dipped but prior to vulcanization of the tire.

Variations of the present invention are possible in light of the description as provided herein. While certain representative embodiments and details have been shown for the purpose of illustrating the subject inventions, it will be apparent to those skilled in the art that various changes and modifications can be made without departing from the scope of the subject inventions.

What is claimed is:

1. A pneumatic tire having a carcass and a belt reinforcing structure, the belt reinforcing structure comprising:
a composite belt structure of cord reinforced layers including at least two radially inner spiral layers and a radially outer zigzag belt reinforcing structure forming two layers of cords, the cords inclined at 5 to 30 degrees relative to the centerplane of the tire extending in alternation to turnaround points at each lateral edge, wherein at least one of the spiral layers is wider than the zigzag belt reinforcing structure.

2. The pneumatic tire of claim 1 further comprising two spiral layers located radially inwards of said zigzag belt reinforcing structure.

3. The pneumatic tire of claim 1 wherein the ratio of the zigzag belt width Wz to the widest spiral belt width Ws is in the range of about: 0.6≦Wz/Ws<1.0.

4. The pneumatic tire of claim 1 wherein one or more of the belts comprise cords made of a nylon and aramid blend.

5. The pneumatic tire of claim 1 wherein one or more of the belts comprise cords made of aramid.

6. The pneumatic tire of claim 1 wherein the belt structure further comprises: two radially inner spiral belt layers, two zigzag belt structures and two radially outer spiral belt layers.

7. The pneumatic tire of claim 1 wherein the tire is a radial aircraft tire having radial plies in the carcass.

8. The pneumatic tire of claim 1 wherein at least one belt ply layer has cords having a percent elongation at break greater than about 11%, and a break strength greater than about 900N with an original linear density of greater than about 9000 dtex.

9. The pneumatic tire of claim 8 wherein the cord has fibers of aramid and nylon.

10. The pneumatic tire of claim 1 wherein the radial carcass ply cord fiber is nylon.

11. The pneumatic tire of claim 1 wherein the spiral layer has first and second belt ends located at near the center of the belt.

12. The pneumatic tire of claim 1 wherein the spiral layer has first and second belt ends offset from the center of the belt a distance less than or equal to ¼ of widest belt width.

13. The pneumatic tire of claim 1 wherein the zigzag belt structure has cords wound continuously from spiral belt layer to zigzag belt structure.

14. The pneumatic tire of claim 1 wherein the zigzag belt structure having cords wound continuously from spiral belt layer to spiral belt layer.

15. The pneumatic tire of claim 1 wherein the radial carcass cord has fibers of polyamide and nylon.

16. The pneumatic tire of claim 1 wherein the merged cords are covered by rubber has 300% modulus (M300) ranges of 12 to 23 mpa.
